(19) United States
(12) Patent Application Publication
(10) Pub. No.: US 2011/0083817 A1
(43) Pub. Date: Apr. 14, 2011

(54) Exterior Solar Shading With Light Redirection

(75) Inventors: Peter BRAYBROOK, Gloucester (GB); Philip Graham GENT, Gloucester (GB); Scott Charles JOHNSON, Solihull (GB)

(73) Assignee: Levolux A.T. Limited, Gloucester (GB)

(21) Appl. No.: 12/899,554

(22) Filed: Oct. 7, 2010

(30) Foreign Application Priority Data
Oct. 13, 2009 (GB) 0917849.2

(51) Int. Cl. E06B 9/386; G02B 5/08

(52) U.S. Cl. 160/236; 359/850

(57) ABSTRACT

Exterior solar shading comprises at least one elongate rigid light-transmissible louver. The louver has an infra-red filter element which prevents or limits the transmission of infra-red energy, and a light redirection element which reflect visible light passing through the louver. The light redirecting element is integrally formed in a major surface of an outer louver element of the louver. Preferably, the light redirecting element is a plurality of formations such as recesses, for example, grooves, or projections, which may preferably have at least one mirrored surface.

### BACKGROUND OF THE INVENTION

Energy conservation is a specific criterion for buildings. Sources of wasted energy come from controlling solar gain within a building, for example via air conditioning units, and also from the extensive use of interior electrical lighting.

It has been suggested in British patent 2385369B to use solar shading on the exterior of a building to control the solar gain within the building and to supplement or replace the interior electrical lighting requirements.

However, the formation of solar shading louvers has been problematic and limiting in their usefulness. It is present practice to cover the two major surfaces of a light transmissible redirecting layer with a layer of PVB, and then sandwich this between two uniform transparent glass sheets. The edges of the louver are sealed against moisture using a continuous opaque external sealing strip, and the louver is then heated to melt the PVB and bond the light transmissible redirecting layer to the clear glass sheets.

The quality of glass must be high and the surfaces smooth and uniform to enable adequate bonding of the PVB thereto, thus preventing, for example, toughened glass being used. This causes health and safety issues. The fact that the edges of the resulting louver are covered by an opaque layer, normally a mechanical trim, to prevent moisture ingress limits use in modem architectural design.

British patent application 0313285.9 attempts to address this problem by utilising cold pour resin as the bonding agent. This does allow the mechanical perimeter trim to be dispensed with, thereby making the shading more architecturally acceptable. However, it does create its own problems due to trapped air bubbles and clouding from adverse chemical reactions at the interface with the agent. This arrangement is also highly labour intensive and delamination has been problematic.

It is therefore a requirement to produce an exterior solar shading panel or louver which can filter at least in part incident infra-red energy and which can redirect incident daylight, whilst also being more cost-effective and reliable to manufacture and at the same time dispensing with the need for a perimeter trim to prevent moisture ingress between panel layers.

### SUMMARY OF THE INVENTION

According to the present invention, there is provided exterior solar shading comprising at least one elongate rigid light-transmissible louver, the said louver having an infra-red filter element preventing or limiting the transmission of infra-red energy, and a light redirection element which reflects visible light passing through the louver, wherein the light redirecting element is integrally formed in a major surface of an outer louver element of the louver.

The invention will now be more particularly described, by way of example only, with reference to the accompanying drawings.

### BRIEF DESCRIPTION OF THE DRAWINGS

FIG. 1 is a perspective view of a first embodiment of exterior solar shading, in accordance with the present invention;

FIG. 2 is a lateral cross-sectional view through one of the louvers shown in FIG. 1, taken along line A-A;

FIG. 3 is a lateral cross-sectional view through a louver of a second embodiment of exterior solar shading, in accordance with the present invention;

FIG. 4 is a lateral cross-sectional view through a louver of a third embodiment of exterior solar shading, in accordance with the present invention; and

FIGS. 5 to 7 show plan views of louvers of fourth to sixth embodiments of exterior solar shading showing different groupings of light redirection grooves, in accordance with the present invention.

### DETAILED DESCRIPTION OF THE PREFERRED EMBODIMENTS

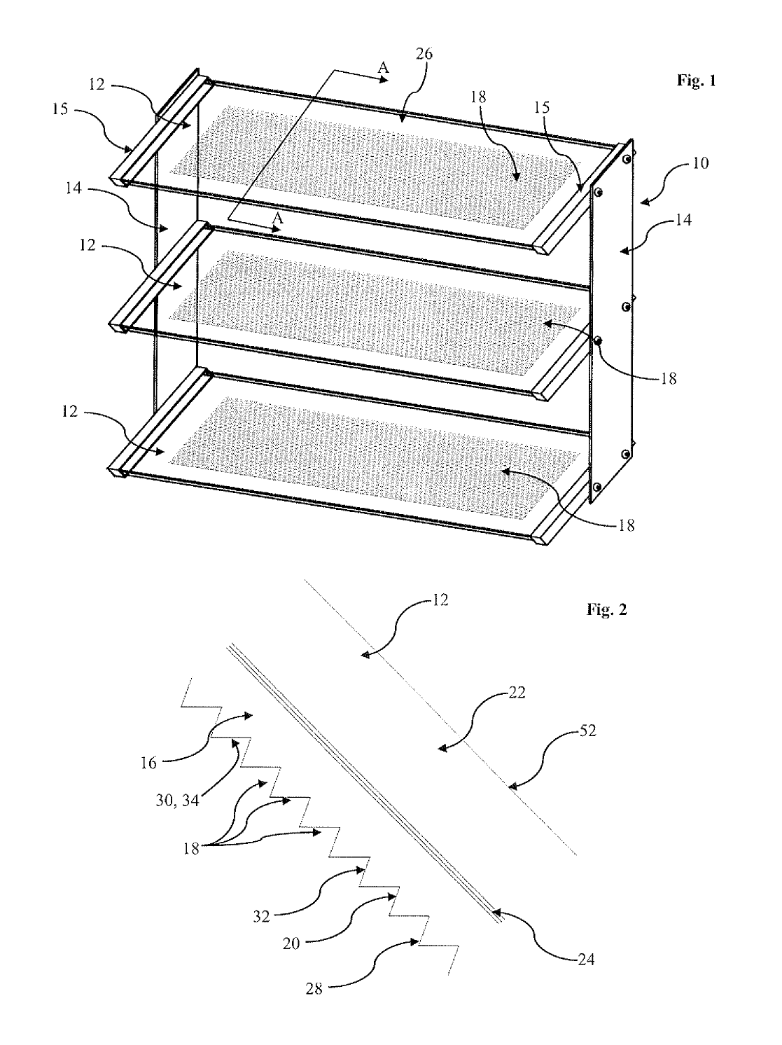

Referring firstly to FIGS. 1 and 2 of the drawings, there is shown exterior solar shading 10 for connection to an exterior of a building, such as via curtain walling mullions. The exterior solar shading 10 comprises a plurality of elongate rigid light-transmissible louvers 12 held in spaced relationship between opposing brackets 14 at each longitudinal end. Each longitudinal end of each louver 12 is preferably received in an end cap 15 which in turn is connected to the bracket 14.

The brackets 14 hold the lateral extents of the louvers 12 at oblique angles, typically being less than 45 degrees from the horizontal, and although at a uniform angle, the angles of the louvers 12 relative to the horizontal may be graduated. In this embodiment also, the louvers 12 are fixed, but they may be selectively adjustable, for example, to accommodate different times of the year.

Each louver 12 comprises a first light-redirection layer 16 of transparent glass having a plurality of grooves 18 integrally formed in an exterior lower major surface 20 thereof, a second support layer 22 which is uniformly transparent, preferably toughened, glass to provide rigidity to the louver 12, and a third layer 24 sandwiched between the first light-redirection layer 16 and the second support layer 22. The third layer 24 is, in this embodiment, a tinted film for filtering at least incident infra-red energy to prevent or limit the transmission of such energy through the louver 12.

The third layer 24 also acts as a bonding layer. Once assembled, the first light-redirection layer 16 and the second support layer 22 have a compressive force applied with heating to melt the third layer 24, thus bonding the three layers together whilst retaining the infra-red filtering.

The plurality of grooves 18, forming light-redirection means, may be formed on the first light-redirection layer 16 pre- or post-assembly of the louver 12.

Each groove 18 is preferably approximately 2 millimetres in depth. However, other depths can be considered.

The grooves 18 are ground by the use of a multi-axis, preferably being 5 axes, CNC cutting machine utilising diamond grinding wheels. Until recently, this type of cutting machine has been unable to achieve the accuracy required for consistently forming the above grooves 18. Consequently, prior to this, laser cutting would have to be relied upon. However, in this latter case, laser cutting cannot be used with glass, since it passes straight through and thus would be discounted. Bespoke multi-directional groove patterns are also much more complicated and thus prohibitively expensive to achieve via laser cutting.

Furthermore, plastics louvers would be discounted since plastics tends to yellow with age, and is also structurally poor.

The grooves 18 preferably extend only partway over the exterior lower major surface 20 of the first light-redirection layer 16, thereby providing a continuous smooth perimeter border 26 therearound. This border 26 increases the structural strength of the louver 12, due to the grooves 18 not extending fully to the edges thereof.

A lateral cross-section of each groove 18 is or is substantially V-shaped. However, to further increase the structural strength and longevity of the louver 12, the apexes between grooves 18 and the troughs of the grooves 18 are preferably slightly rounded to prevent or limit facture or fault lines.

The grooves 18 utilise the properties of internal reflection, and typically total internal reflection although some direct passing through of light may occur with partial internal reflection occurring, to redirect light transmitted through the louver 12 into an upper part of a room of a building. The light is reflected internally at the side walls 30 of the grooves 18 before the light exits the louver 12 via the lower surface 28. Due to the angle of the louver 12 itself, the reflected light is directed generally upwardly through an adjacent window pane and towards a ceiling of a room.

To better achieve the desired angle of reflection, the lower side wall 32 of each groove 18 has a different pitch, preferably being steeper, than the adjacent upper side wall 34. A uniformly serrated profile across the grooves 18 is thus created. Reflection occurs at the upper side wall 34, and due to the pitch of the lower side wall 32, refraction is kept to a minimum as light leaves the louver following reflection.

In this embodiment, the grooves 18 are formed together as a single uniform group. Each groove 18 is rectilinear, and has a longitudinal extent which extends in parallel with the longitudinal extent of the louver 12.

Although FIG. 1 shows each louver 12 of the exterior solar shading 10 having the grooves 18, only one of the louvers 12 may need to have the infra-red filter means and/or the light-redirection means. One or more of the remaining louvers 12 can thus be standard known types.

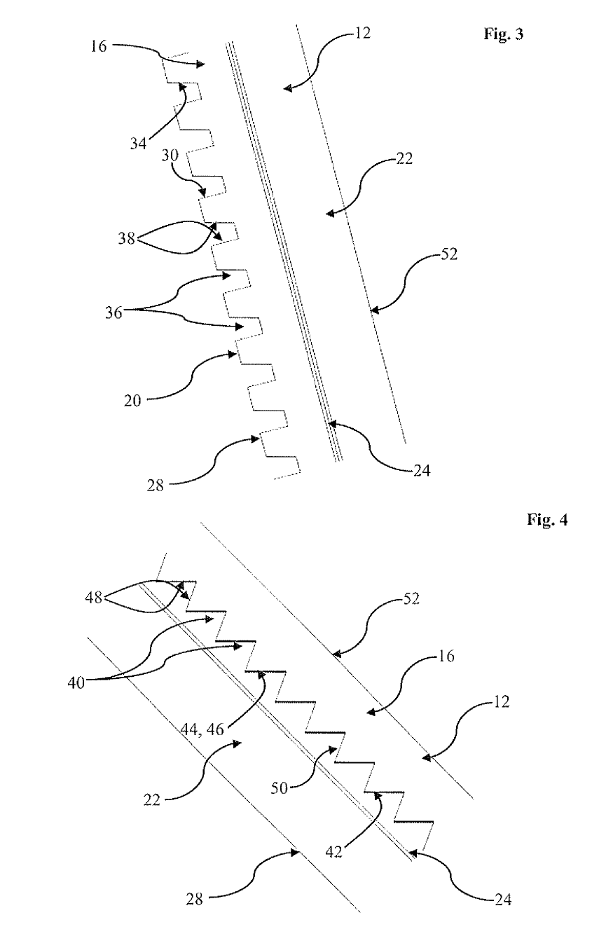

Referring to FIG. 3, a lateral cross-section of a louver 12 of a second embodiment of exterior solar shading 10 is shown. This lateral cross-section is taken along a similar line A-A as that in FIG. 1. Due to the similarities with the first embodiment, like references refer to like parts and further detailed description is omitted.

In this embodiment, it is only the groove shapes which are changed. The elongate rigid louver 12 retains the transparent first light-redirection layer 16 with grooves 36 on the exterior lower major surface 20, the second support layer 22 of uniformly transparent, preferably toughened, glass, and the intermediate tinted layer 24 for filtering infra-red energy as well as bonding the first and second layers 16, 22 together. Although a tinted intermediate layer is suggested, ideally the intermediate layer will have no tint so as to allow as much incident visible light through as possible, whilst fully or partially filtering unnecessary parts of the invisible spectrum, such as infra-red and preferably also ultra-violet.

The grooves 36 have a castellated or squared lateral profile. Again, the grooves 36 are uniform relative to each other, and again have opposing side walls 38 which are of different pitches. The castellated profile enables spacing of the side walls 38 and thus less chance of impingement of reflected light rays when exiting the exterior lower major surface 20 of the louver 12.

Although the side walls 38 of the grooves 36 in the preceding and following embodiments are preferably of different pitches, they may have the same pitch.

Referring to FIG. 4, a lateral cross-section of a louver 12 of a third embodiment of exterior solar shading 10 is shown. This lateral cross-section is taken along a similar line A-A as that in FIG. 1. Due to the similarities with the first embodiment, like references refer to like parts and further detailed description is omitted.

The main difference between this embodiment and the preceding embodiments is that the grooves 40 are formed on an internal upper major surface 42 of the louver 12, and not on the exterior lower major surface 20. Consequently, the grooves 40 are formed on the first light-redirection layer 16 prior to bonding with the second support layer 22 and the third intermediate layer 24 of the louver 12.

In this third embodiment, direct reflection is mainly utilised as opposed to, typically total, internal reflection as in the prior embodiments. To this end, the upper side wall 44 of each groove 40 includes a discrete reflector 46. The reflector 46 is preferably a mirrored or silvered surface, and is preferably opaque but may be semi-transparent. This therefore functions as a partial micro-blind, providing physical direct shading. The reflector 46 is typically applied following formation of the grooves 40 and faces into the light-redirecting layer 16. In this case, both side walls 48 of each groove 40 may be covered with the reflector material, and then the grooves 40 are re-machined to grind or remove the reflector 46 from the lower side wall 50.

This arrangement can be reversed, and when the light-redirecting layer is on the bottom, the reflector would face towards the support layer thereabove.

The reflector 46 is conveniently protected by being positioned internally within the louver 12. The intermediate third layer 24 comprising the infra-red filter means overlies the grooves 40, and once heated, flows into the grooves 40 to bond the first light-redirection layer 16 and the second support layer 22 together.

In use, light transmitted through the light redirection layer 16 is internally incident on the reflectors 46 on the upper side walls 44 of the grooves 40. Following reflection, it is filtered by the third intermediate layer 24 and exits through the second support layer 22. By imparting a steeper pitch to the lower side walls 50 of the grooves 40, the light reflected by the reflectors 46 is less likely to be obstructed and is thus directed in a rising direction into an adjacent room.

With the embodiments described above, the third intermediate layer 24 includes a tint which filters at least infra-red energy. However, as also mentioned, the intermediate layer would preferably be without a tint to allow the passage of as much visible light as possible. The tint utilised is preferably green, which is the least obtrusive. However, a brown tint or other colours can be considered. However, the filter means may also filter other type of radiation, such as ultra-violet. To prevent or limit solar gain within a building, filtering of the infra-red wavelengths is essential to the present invention.

The infra-red filter means may be incorporated as part of the second support layer 22. In this case, the infra-red filter means is preferably integrally formed as one-piece with the second support layer 22. However, less preferably it may be provided as a laminate on the exterior lower or upper major surfaces 28, 52. In this case, the third intermediate layer 24 may only provide bonding.

As another alternative, the louver 12 may only comprise a single layer. In this case, the single layer is integrally formed as one-piece with the filter means, typically as an infra-red filtering tint. Following this, the grooves are formed on the exterior lower major surface of the single layer to provide the light redirection means.

The grooves 18, 36, 40 described above are all uniform relative to one another. However, the grooves may be graduated across the lateral extent of the group in terms of side wall pitch in order to accommodate changes in the direction of incident daylight. As a consequence, a first groove would have a side wall with a first pitch and a second neighbouring groove would have an equivalent side wall with a second pitch which is different to that of the first pitch.

Although the grooves described above have a or a substantially V-shaped lateral cross-section, other shapes are possible. For example, the lateral cross-sectional shape may be part-sinusoidal or curved.

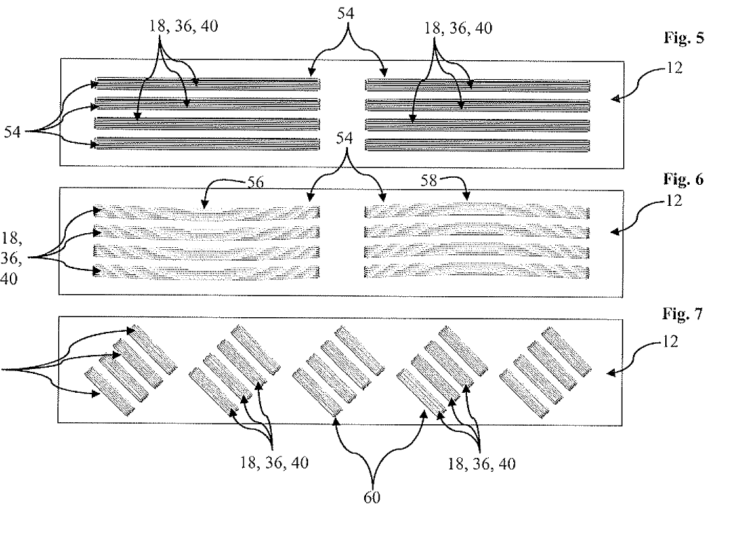

Referring now to FIG. 5, there is shown a plan view of a louver 12 of a fourth embodiment of exterior solar shading 10. Like references refer to like parts and further detailed description is omitted.

In this embodiment, the grooves 18, 36, 40 are shaped and formed as described above. However, rather than having a single group of grooves 18, 36, 40, a plurality of groups 54 of grooves 18, 36, 40 are provided in spaced apart relationship. This is beneficial in that it improves the structural strength of louver 12.

As shown in FIG. 6, which depicts a fifth embodiment of exterior solar shading 10, the grooves 18, 36, 40 may be arcuate rather than rectilinear. In this case, the grooves 18, 36, 40 are again split into groups 54, and the overall arcuate nature of the grooves 18, 36, 40 is generally sinusoidal. It will be appreciated in FIG. 6, that the groups 56 of grooves 18, 36, 40 on the one side of the louver 12 describe a concave shape, whilst the groups 58 of grooves 18, 36, 40 on the other side describe a convex shape.

In the fourth and fifth embodiments, rather than having groups of grooves which are spaced apart in the lateral and longitudinal directions, it is possible to have groups of grooves which are only spaced apart in one of the lateral and longitudinal directions.

FIG. 7 shows a louver 12 of a final sixth embodiment of exterior solar shading 10. Again, like references refer to like parts.

In this embodiment, a plurality of groups 60 of grooves 18, 36, 40 are provided, and a longitudinal extent of each group is oblique to the longitudinal and lateral extents of the louver 12. Each group 60 of grooves 18, 36, 40 is spaced apart from each other, and divided into sub-groups 62 of grooves 18, 36, 40 which themselves are spaced apart from the other sub-groups 62 within the respective group 60.

The arrangements shown in the embodiments of FIGS. 5 to 7 are beneficial for different types of buildings with different orientations and requiring not only light redirection in the vertical plane but also light redirection in the horizontal plane. This thus allows daylight to not only be directed towards an upper portion or ceiling of a room, but also specifically targeted at portions of the room which might be central or more towards one wall or another.

It is also entirely feasible using the grinding manufacturing method described above that a louver can be formed with groups of grooves wherein each group has an orientation, cross-sectional groove shape, and/or longitudinal groove shape which is different to those of other groups. A bespoke pattern of grooves can thus be produced.

Although grooves are suggested above, the light redirection means may feasibly utilise projections. The grooves may not be elongate and may be, for example, dimples. The term ‘recess’ is thus intended to cover not only grooves but also dimples and other shapes of indentation. If projections are utilised, the projections may be elongate or for example rounded. The term ‘formation’ is intended to encompass recesses and/or projections, herein and throughout.

Although grinding is suggested to form the light redirection means, moulding may be considered.

With the light redirection means on the exterior lower major surface of the louver, a stay clean coating may be applied to prevent or limit the accumulation of dirt and other particulate matter and detritus.

The light redirection means has to be on an exterior lower major surface of the louver, an interior upper major surface, or on an interior lower major surface of the louver. However, it is possible that additional supplementary light redirection means could be included on other major surfaces of the louver.

It is thus possible to provide exterior solar shading having a louver which prevents or limits infra-red transmission, thereby reducing solar gain in a building, but which also has light redirection means for supplementing or replacing high level interior building lighting through the use of reflected daylight. The louver allows the passage of the maximum amount of visible spectrum light whilst filtering infra-red and, preferably also, ultra-violet. The louver is cost-effective to manufacture and is reproducible in bulk quantities. It is also possible to provide a louver which does not require perimeter cladding or framing to protect the minor perimeter side edges or surfaces of the louver, thereby appealing to architectural design, without exposing layers of the louver to moisture ingress therebetween and damage through delamination. The problems associated with resin bonding and trapped air pockets in multi-layered louvers are overcome by the use of an intermediate preformed flexible film layer which may conveniently include the infra-red filter means. These problems are further overcome by providing the light redirection means integrally as one-piece with an exterior layer of the louver, and this may be either on an exterior lower major surface of the louver, on an interior lower major surface of the louver, or on an interior upper major surface of the louver whereby incident light is reflected at predetermined angles.

The embodiments described above are provided by way of examples only, and various other modifications will be apparent to persons skilled in the art without departing from the scope of the invention as defined by the appended claims.

What is claimed is:—

1. Exterior solar shading comprising at least one elongate rigid light-transmissible louver, the said louver having an infra-red filter element preventing or limiting the transmission of infra-red energy, and a light redirection element which reflects visible light passing through the louver, wherein the light redirecting element is integrally formed in a major surface of an outer louver element of the louver.

2. Exterior solar shading as claimed in claim 1, wherein the light redirection element is provided on an exterior surface of the outer louver element of the louver.

3. Exterior solar shading as claimed in claim 2, wherein the light redirection element is provided on an underneath exterior surface of the outer louver element of the louver.

4. Exterior solar shading as claimed in claim 1, wherein the light redirection element is provided on an interior facing surface of a first said outer louver element of the louver.

5. Exterior solar shading as claimed in claim 1, wherein the light redirecting element includes a plurality of spaced apart mirror elements.

6. Exterior solar shading as claimed in claim 1, wherein the light redirection element includes a plurality of grooves formed integrally in the said major surface of the outer louver element.

7. Exterior solar shading as claimed in claim 6, wherein a pitch of one side of one of the said grooves is different to a pitch of the other side of the said one groove.

8. Exterior solar shading as claimed in claim 1, wherein the major surface of the outer louver element is an exterior major surface of the louver.

9. Exterior solar shading as claimed in claim 1, wherein the major surface of the outer louver element is an interior major surface of a layer forming the said louver.

10. Exterior solar shading as claimed in claim 1, wherein the outer louver element is a light-redirection layer having the light redirection element, and the louver further includes a support layer which supports the light-redirection layer.

11. Exterior solar shading as claimed in claim 10, wherein the support layer is integrally formed with the infra-red filter element as one-piece.

12. Exterior solar shading as claimed in claim 10, wherein the support layer is a strengthening layer, and a third layer having the infra-red filter element is interposed between the support layer and the light-redirection layer.

13. Exterior solar shading as claimed in claim 10, further comprising a further bonding layer which bonds the support layer and the light-redirection layer together.

14. Exterior solar shading as claimed in claim 10, wherein the light redirection element is provided on the light-redirection layer so as to be on an interior major surface of the louver.

15. Exterior solar shading as claimed in claim 14, wherein the light redirection element includes a discrete reflector.

16. Exterior solar shading as claimed in claim 15, wherein the discrete reflector is a mirror.

17. Exterior solar shading as claimed in claim 15, wherein a reflecting surface of the discrete reflector faces into the light-redirection layer.

18. Exterior solar shading as claimed in claim 15, wherein a reflecting surface of the discrete reflector faces towards the support layer.

19. Exterior solar shading as claimed in claim 15, wherein the light redirection element includes a plurality of grooves, and a said discrete reflector is provided on one wall of each said groove.

20. Exterior solar shading as claimed in claim 10, wherein the light redirection element is provided on an outwardly facing major surface of the light-redirection layer.
